(19) United States
(12) Patent Application Publication
(10) Pub. No.: US 2014/0090205 A1
(43) Pub. Date: Apr. 3, 2014

(54) Reduced Barrel Hinge

(71) Applicant: GEM PRODUCTS, INC., Orange Park, FL (US)

(72) Inventors: Jason Sarnowski, Jacksonville, FL (US); Erle Matthew Bridgewater, St. Johns, FL (US)

(73) Assignee: GEM PRODUCTS, INC., Orange Park, FL (US)

(21) Appl. No.: 13/630,815

(22) Filed: Sep. 28, 2012

(51) Int. Cl. E05D 3/02; E05D 5/14; B23P 15/00; E05D 5/04

(52) U.S. Cl. 16/387; 29/11

(57) ABSTRACT

A hinge is disclosed with a barrel having a reduced thickness compared to a conventional barrel hinge. The arms that form the barrel are reduced in thickness prior to curling the arms so that a relatively thin barrel is achieved. The disclosed hinge can therefore be used as a flush mount hinge with minimal alteration to the objects to which it is coupled. The hinge can also be used as a top mount hinge with fewer safety issues in, for example, boating operations, where the hinge may be located in an area typically walked upon by people or animals. The disclosed hinge is easy to manufacture because the small arms require less force to curl, and yet the hinge portions can remain relatively thick to couple together heavy objects requiring high structural stability.

### TECHNICAL FIELD OF THE INVENTION

The present application relates to hinges. Particularly, the present application relates to a hinge with a reduced barrel size.

### BACKGROUND OF THE INVENTION

Hinges are a well-known means of pivotably coupling together two objects, such as a door to a frame. For example, a barrel hinge can couple at one end to a door, and another end to a frame, and the door can rotate about the barrel of the hinge to open and close relative to the frame.

The barrel of a barrel hinge is typically formed by curling elongated arms of a hinge portion around a pin so the hinge portion can rotate about the pin. Alternatively, the arms can be curled in advance and the pin can be inserted into an opening formed by the curled arms, rather than curling the arms around the pin itself. In either scenario, the thickness of the barrel is dependent on the thickness of the arms that are curled to form the barrel.

A thick barrel can be problematic for flush mount hinges. A flush mount hinge couples two objects together with the barrel of the hinge facing into the space between the two objects. A cutout is typically formed in the two objects to provide space for the barrel. As the barrel size increases, so too does the amount of alteration required to form the cutout.

Flush mount hinges are commonly used in boating applications, for example, to hinge a hatch used on the deck of a boat. Alternatively, top mount hinges can be implemented, where the barrel of the hinge faces away from the objects being coupled and therefore does not require any cutout. Top mount hinges can be problematic because boaters often walk barefoot on a deck and can injure themselves by stubbing their toe or tripping over a large hinge barrel in the top mount configuration.

In machining the hinge, it can be difficult to curl a thick hinge portion around the pin to form a barrel of a barrel hinge. At the same time, a thick hinge portion may be needed for structural stability, for example, to couple a heavy door to a frame.

### SUMMARY OF THE INVENTION

The present application discloses a hinge and method of manufacturing a hinge with a reduced-size barrel as compared to the conventional hinge. The arms of the hinge portion are thinner than the remainder of the hinge portion, resulting in a smaller barrel size.

In particular, the present application discloses a hinge including a pin and a hinge portion including a body, and an arm integrally coupled to the body and extending therefrom, the arm being reduced in thickness in at least a portion of the arm as compared to the body and further being curled to form an opening to accommodate at least a portion of the pin.

The present application also discloses a method of manufacturing a hinge including machining a hinge blank to form an arm and a body, reducing a thickness of the arm without reducing a thickness of the body, thereby forming a hinge portion, and curling the hinge portion to provide an opening to accommodate the pin.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is hinge according to an embodiment of the present application.

FIG. 2 is a hinge portion blank according to an embodiment of the present application.

FIG. 3 is a machined hinge portion blank with angled corners according to an embodiment of the present application.

FIG. 4 is a machined hinge portion blank with angled corners and fastener holes according to an embodiment of the present application.

FIG. 5 is a machined hinge portion blank with angled corners, fastener holes, and reduced thickness arms according to an embodiment of the present application.

FIG. 6 is an exploded view of a hinge prior to the arms being curled over a pin according to an embodiment of the present application.

FIG. 7 is a flow chart illustrating an exemplary method of manufacturing the hinge.

It should be understood that the comments included in the notes as well as the materials, dimensions and tolerances discussed therein are simply proposals such that one skilled in the art would be able to modify the proposals within the scope of the present application.

### DETAILED DESCRIPTION OF THE EMBODIMENTS

While this invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated.

The present application discloses a hinge with a barrel having a reduced thickness compared to a conventional barrel hinge. The hinge includes arms that are reduced in thickness relative to the hinge body portions prior to the arms being curled. The curled arms form a relatively thin barrel portion. Embodiments of the disclosed hinge can be used as a flush mount hinge with minimal alteration to the objects to which it is coupled, or as a top mount hinge with improved safety for on-deck mounting. Embodiments of the disclosed hinge facilitate simplified manufacturing by including small arm portions, which require less force to curl over the hinge pin, and retain high structural stability by including relatively thick body portions to couple together heavy objects requiring high structural stability.

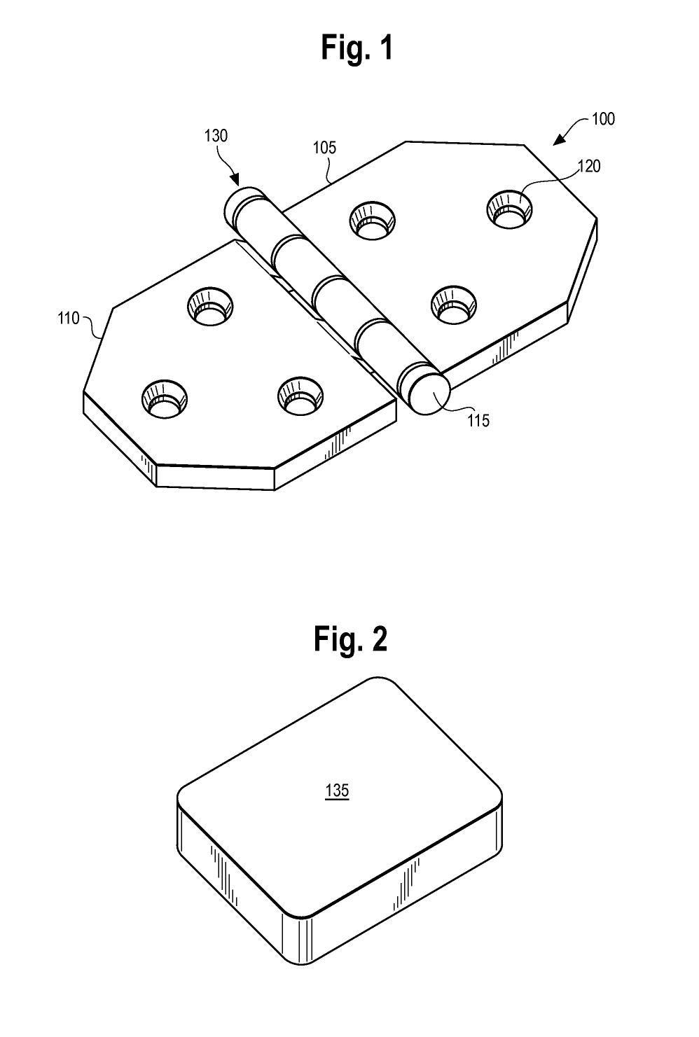

FIGS. 1-6 disclose a reduced-barrel hinge and method of manufacturing the reduced-barrel hinge according to an embodiment of the present application. As shown, FIG. 1 illustrates a hinge 100 having a first hinge portion 105 and a second hinge portion 110 each connected to a pin 115. The hinge portions 105, 110 can include fastener holes 120 to receive, for example, screws or other fasteners that couple the hinge portions 105, 110 to objects, such as a door or a frame. The hinge portions 105, 110 form a barrel 130 that is reduced in size as compared to a conventional barrel hinge, which would have a barrel thickness dependent upon the thickness of the hinge portions 105, 110. In particular, the hinge portions 105, 110 are machined in such a manner to reduce the thickness of the hinge portion 105, 110 in areas that form the barrel 130, providing a smaller barrel 130 relative to the remainder of the hinge portion 105, 110.

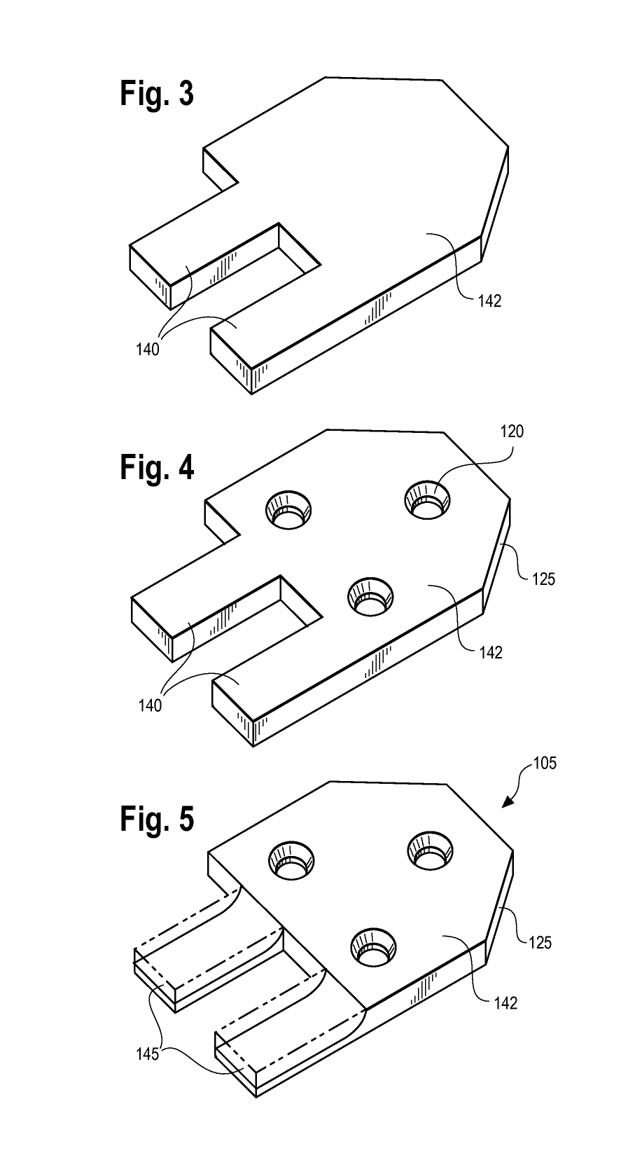

FIG. 2 illustrates a hinge portion blank 135 according to the embodiment of the present application. As shown, the hinge portion blank 135 is substantially square or rectangular in shape. However, the hinge portion blank 135 can be any shape without departing from the spirit and scope of the present application. The hinge portion blank 135 can serve as the original material that is stamped and/or machined in order to form one of the two hinge portions 105, 110. To that end, the hinge portion blank 135 can be provided in any shape, including the shapes shown in FIGS. 3-6, to reduce the number of stamping and/or machining operations performed by the hinge manufacturer.

FIG. 3 illustrates a hinge portion 105, 110 that has been further stamped and/or machined to form arms 140 and a body 142. As shown, the hinge portion 105, 110 includes two arms, but any number of arms can be implemented without departing from the spirit and scope of the present application. Also, the arms 140 are shown integral to the body 142. However, the arms can be coupled to the body 142, such as by adhesive or welding.

FIGS. 3 and 4 illustrate the result of various machining operations that can be formed to the hinge portion 105, 110 for functional and/or aesthetic purposes. For example as shown in FIG. 3, the hinge portion 105, 110 can be machined to form an angled corner 125. Further, as shown in FIG. 4, the hinge portion 105, 110 can be machined to include fastener holes 120 that are adapted to receive fasteners such as screws, nails or any other fastener that may couple the hinge portion 105, 110 to an object. It should be understood that a variety of different stamping and/or machining operation can be performed to the hinge portion 105, 110 without departing from the spirit and scope of the present application. For example, the user can perform a machine operation on the hinge portion 105, 110 to produce a fillet or chamfer along any of the edges of the hinge portion 105, 110. Also, the fastener holes 120 can be any shape, for example, a bore, counterbore, countersink, or any other shape that can receive a fastener to couple the hinge portion 105, 110 to an object such as a door, hatch, or frame, for example. Any other machining operation can be performed to the hinge 100 without departing from the spirit and scope of the present application.

FIG. 5 shows a hinge portion 105, 110 with a reduced thickness arm 145 according to an embodiment of the present application. As shown, the reduced thickness arm 145 is thinner than the body 142 of the hinge portion 105, 110. The reduced thickness arm 145 can be reduced in thickness by either pressing and/or compressing the arm 140 until the desired shape of the reduced thickness arm 145 is obtained. Alternatively, material can be removed from the arm 140 in order to obtain the desired shape. It should be understood that a variety of different of pressing, stamping and/or machining operation can be used in order to achieve the desired shape of the reduced thickness arm 145. Such operations include, but are not limited to, a lathing operation, a pressing operation, cold work operations, and hot work operations, for example.

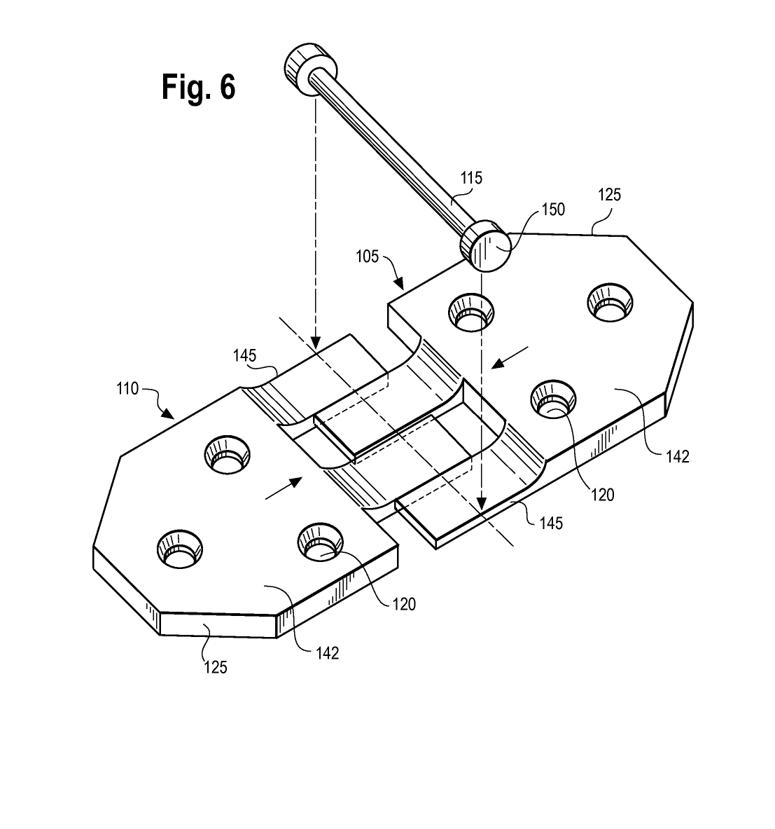

FIG. 6 illustrates an exploded view of the hinge portion 105, 110 and the pin 115 according to the an embodiment of the present application. As shown, the hinge portion 105, 110 includes reduced thickness legs 145 that can be curled to form an opening to accommodate the pin 115. Alternatively, the legs 145 can be curled around the pin 115 in a single operation. The pin 115 can include one or more caps 150 positioned at axial ends of the pin 115 to maintain the hinge portions 105, 110 on the pin 115. Once the reduced thickness arms 145 are curled, the pin 115 can be inserted into the opening formed by the curls, resulting in the reduced thickness arms 145 being curled around the pin 115.

As shown in FIG. 1, the hinge includes a barrel 130 that is reduced in thickness as compared to what would be formed if the legs 140 of the hinge portions 105, 110 were not reduced in thickness. Accordingly, the present application discloses a hinge that is more advantageous for flush mount hinge operations, for boating operations where the hinge will be located in a walking area, and for easier manufacturing.

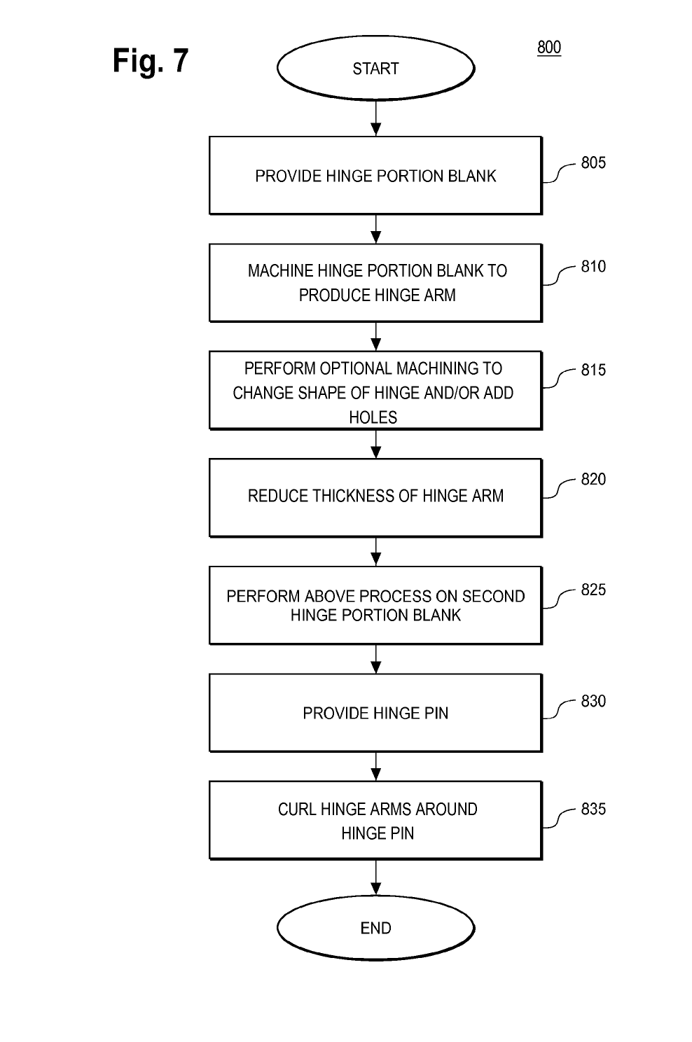

FIG. 7 illustrates a flow chart disclosing a method of manufacturing the hinge 100 according to the present application. As shown, the process 800 begins and proceeds to step 805 where a first hinge portion 105, 110 is selected. Once selected, the first hinge portion 105 can be machined in order to produce a first hinge portion 105 having an arm 140 and a body 142, as shown in step 810. It should be understood that the first hinge portion 105 can be cast with the arm 140 and body 142 already provided without any additional machining operation. Further optional machining can then be performed on the first hinge portion 105 to change the shape of the hinge 100, for example, to provide angled corners or to add fastener holes 120 to the hinge 100, as shown in step 815. In step 820, the thickness of the hinge arm 140 is then reduced, and in step 825, the above process is performed on a second hinge portion 110. A hinge pin 115 can then be selected in step 830 and the hinge arms 140 can be curled around the hinge pin in step 835 in order to produce the hinge 100.

The above hinge 100 is disclosed as being made from machining operations that begin with a blank and that reduce or compress material in order to form the desired shape. However, the above hinge can also be performed by one or more casting operations in which the hinge parts are cast rather than machined. Any other manufacturing method can be performed in order to produce the desired shape of the hinge discussed above.

The above hinge 100 is discussed as being either a top mount or flush mount hinge. However, any form of hinge can be implemented without departing from the spirit and scope of the present application. For example, and without limitation, the hinge 100 can be a top mount, flush mount, swaged, offset, or any other form of barrel hinge.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1. A hinge comprising:
a pin;
a first hinge portion including:
a first body; and
first arms integrally coupled to the first body and extending therefrom, at least a portion of the first arms having a substantially uniform thickness that is less than a thickness of the first body; and
a second hinge portion including:
a second body; and
a second arm integrally coupled to the second body and extending therefrom, at least a portion of the seeond arm having a substantially uniform thickness that is less than a thickness of the second body,
the second arm disposed between at least two of the first arms; and
the first and second arms being curled to form an opening to accommodate at least a portion of the pin.

2. The hinge of claim 1, further comprising fastener holes adapted to receive a fastener formed in the first and second bodies.

3. The hinge of claim 1, wherein the first and second bodies include angled corners.

4. The hinge of claim 1, wherein the pin includes a cap disposed at an axial end of the pin.

5. A method of inanufacturing a hinge comprising:
machining a first hinge blank to form a first body and first arms extending from the first body;
machining a second hinge blank to form a second body and a second arm extending from the second body;
reducing a substantially uniform thickness of the first and second arms without reducing a thickness of the first and second bodies;
curling the first and second arms to provide an opening;
disposing the second arm between at least two of the first arms; and
disposing a pin within the opening.

6. The method of claim 5, further comprising machining the first and second hinge blanks to form respective angled corners of the first and second bodies.

7. The method of claim 5, further comprising machining the first and second hinge blanks to form respective fastener holes in the first and second bodies.

8. The method of claim 5, further comprising coupling a cap to an end of the pin.

9. The method of claim 5, wherein the step of reducing the thickness of the first and second arms is performed by a press.

10. The method of claim 5, wherein the step of reducing the thickness of the first and second arms is performed by a lathe.

11. The method of claim 5, wherein the step of reducing the thickness of the first and second arms is performed by compressing the first and second arms.

12. The method of claim 5, wherein the step of reducing the thickness of the first and second arms is performed by reducing material forming the first and second arms.
